(19) United States
(12) Patent Application Publication
(10) Pub. No.: US 2012/0169790 A1
(43) Pub. Date: Jul. 5, 2012

(54) APPARATUS, DISPLAY DEVICE, METHOD, PROGRAM, STORAGE MEDIUM AND LOOKUP TABLE FOR OPERATING A DISPLAY DEVICE COMPRISING A DISPLAY PANEL

(75) Inventors: Benjamin John Broughton, Oxford (GB); Meelis Lootus, Oxford (GB); Kenji Maeda, Osaka (JP); Tatsuo Watanabe, Osaka (JP); Yoshimitsu Inamori, Osaka (JP); Takashi Yasumoto, Osaka (JP)

(73) Assignee: SHARP KABUSHIKI KAISHA, Osaka (JP)

(21) Appl. No.: 13/394,822

(22) PCT Filed: Sep. 16, 2010
(86) PCT No.: PCT/JP2010/066614

§ 371 Date: Mar. 8, 2012

(30) Foreign Application Priority Data
Sep. 16, 2009 (GB) 0916241.3

(51) Int. Cl. G09G 5/10

(52) U.S. Cl. 345/690

(57) ABSTRACT

A method of operating a display device comprising a display panel comprises receiving main and side image pixel data respectively representing a main image (S1) and a side image (S2). For each of a plurality of pixel groups (S3), where each pixel group comprises at least one pixel of the main image pixel data and at least one spatially corresponding pixel of the side image pixel data, a predetermined mapping is performed (S4) using the pixel data of the pixel group as input. The mapping holds output pixel data for the input pixel data which is known to produce an average on-axis luminance with substantially no dependence on the side image pixel data of the group and an average off-axis luminance with substantially no dependence on the main image pixel data of the group. The signals used to drive the display panel are determined from the output pixel data (S5).

### TECHNICAL FIELD

The present invention relates to an apparatus, display device, method, program, storage medium and lookup table for operating a display device (such as an active matrix display device which is operable in a private display mode) comprising a display panel.

### BACKGROUND ART

In a first, public, mode of a display device that is switchable between a public and private display mode, the device commonly behaves as a standard display. A single image is displayed by the device to as wide a viewing angle range as possible, with optimum brightness, image contrast and resolution for all viewers. In the second, private mode, the main image is discernible only from within a reduced range of viewing angles, usually centred on the normal to the display surface. Viewers regarding the display from outside this reduced angular range will perceive either a second, masking image which obscures the main image, or a main image so degraded as to render it unintelligible.

This concept can be applied to many devices where a user may benefit from the option of a privacy function on their normally wide-view display, for use in certain public situations where privacy is desirable. Examples of such devices include mobile phones, Personal Digital Assistants (PDAs), laptop computers, desktop monitors, Automatic Teller Machines (ATMs) and Electronic Point of Sale (EPOS) equipment. Such devices can also be beneficial in situations where it is distracting and therefore unsafe for certain viewers (for example drivers or those operating heavy machinery) to be able to see certain images at certain times, for example an in car television screen while the car is in motion.

Several methods exist for adding a light controlling apparatus to a naturally wide-viewing range display:

One such structure for controlling the direction of light is a ‘louvred’ film. The film consists of alternating transparent and opaque layers in an arrangement similar to a Venetian blind. Like a Venetian blind, it allows light to pass through it when the light is travelling in a direction nearly parallel to the layers, but absorbs light travelling at large angles to the plane of the layers. These layers may be perpendicular to the surface of the film or at some other angle. Methods for the production of such films are described in a U.S. Pat. No. RE27,617 (F. O. Olsen; 3M 1973), U.S. Pat. No. 4,766,023 (S.-L. Lu, 3M 1988), and U.S. Pat. No. 4,764,410 (R. F. Grzywinski; 3M 1988).

Other methods exist for making films with similar properties to the louvred film. These are described, for example, in U.S. Pa. No. 5,147,716 (P. A. Bellus; 3M 1992), and U.S. Pat. No. 5,528,319 (R. R. Austin; Photran Corp. 1996).

Louvre films may be placed either in front of a display panel or between a transmissive display and its backlight to restrict the range of angles from which the display can be viewed. In other words, they make a display “private”.

The principal limitation of such films is that they require mechanical manipulation, i.e. removal of the film, to change the display between the public and private viewing modes:

In GB2413394 (Sharp, 2004), an electronically switchable privacy device is constructed by adding one or more extra liquid crystal layers and polarisers to a display panel. The intrinsic viewing angle dependence of these extra elements can be changed by switching the liquid crystal electrically in the well-known way. Devices utilising this technology include the Sharp Sh851i and Sh902i mobile phones.

The above methods suffer the disadvantage that they require the addition of extra apparatus to the display to provide the functionality of electrically switching the viewing angle range. This adds cost, and particularly bulk to the display, which is very undesirable, particularly in mobile display applications such as mobile phones and laptop computers.

Methods to control the viewing angle properties of an LCD by switching the single liquid crystal layer of the display between two different configurations, both of which are capable of displaying a high quality image to the on-axis viewer are described in US20070040780A1 (Sharp, 2005) and WO2009057417A1 (Sharp, 2007). These devices provide the switchable privacy function without the need for added display thickness, but require complex pixel electrode designs and other manufacturing modifications to a standard display.

An example of a display device with privacy mode capability with no added display hardware complexity is disclosed in WO 2009/069048. Another such example is provided in US20090079674A1, which discloses a privacy mode for a display in which different levels of signal voltage are applied to adjacent pixels so that an averaged brightness of those pixels varies with the signal voltages according to the display's gamma curve to show an expected image when viewed on axis, and in which the averaged brightness is at a constant level within a specified voltage range when viewed off axis, so as to change a contrast of the image to a visibly unidentifiable degree off axis.

Another example of a display device with privacy mode capability with no added display hardware complexity is the Sharp Sh702iS mobile phone. This uses a manipulation of the image data displayed on the phone's LCD, in conjunction with the angular data-luminance properties inherent to the liquid crystal mode used in the display, to produce a private mode in which the displayed information is unintelligible to viewers observing the display from an off-centre position. However, the quality of the image displayed to the legitimate, on-axis viewer in the private mode is severely degraded.

A similar schemes to that used on the Sh702iS phone, but which manipulate the image data in a manner dependent on a second, masking, image, and therefore causes that masking image to be perceived by the off-axis viewer when the modified image is displayed, are given in GB2428152A1 (published on 17 Jan. 2007) and GB application GB0804022.2 (published as GB2457106A on 5 Aug. 2009). The method disclosed in the above publications uses the change in data value to luminance curve with viewing angle inherent in many liquid crystal display modes such as “Advanced Super View” (ASV) (IDW'02 Digest, pp 203-206) or Polymer Stabilised Alignment (PSA) (SID'04 Digest, pp 1200-1203).

The data values of the image displayed on the LC panel are altered in such a way that the modifications applied to neighbouring pixels effectively cancel out when viewed from the front of the display (on-axis), such that the main image is reproduced, but when viewed from an oblique (off-axis) angle, the modifications to neighbouring pixels result in a net luminance change, dependent on the degree of modification applied, so the perceived image may be altered.

In the method described in GB2428152A1 and GB2457106A, the image data modifications are calculated in such a way that the change in average luminance observed by the off-axis viewer is dependent on the second, side, image. However, the present applicant has appreciated that the absolute luminance of a pair of modified pixels, as observed by the off-axis viewer, is still also partially dependent on the main image. As a result, the off-axis viewer will perceive some degree of main image information “leaking” through the intended side image. It is desirable to address this issue.

### SUMMARY OF INVENTION

According to a first aspect of the present invention, there is provided a method of operating a display device comprising a display panel, the method comprising receiving main image pixel data representing a main image, and side image pixel data representing a side image, and for each of a plurality of pixel groups, where each pixel group comprises at least one pixel of the main image pixel data and at least one spatially corresponding pixel of the side image pixel data: performing a predetermined mapping using the pixel data of the pixel group as input, wherein the mapping is arranged to hold output pixel data for the input pixel data which is known to produce an average on-axis luminance which is dependent on the main image pixel data of the group with substantially no dependence on the side image pixel data of the group and an average off-axis luminance which is dependent on the side pixel data of the group with substantially no dependence on the main image pixel data of the group; and determining from the output pixel data the signals used to drive the display panel.

According to a second aspect of the present invention, there is provided an apparatus arranged to perform a method of operating a display device comprising a display panel, the method comprising receiving main image pixel data representing a main image, and side image pixel data representing a side image, and for each of a plurality of pixel groups, where each pixel group comprises at least one pixel of the main image pixel data and at least one spatially corresponding pixel of the side image pixel data: performing a predetermined mapping using the pixel data of the pixel group as input, wherein the mapping is arranged to hold output pixel data for the input pixel data which is known to produce an average on-axis luminance which is dependent on the main image pixel data of the group with substantially no dependence on the side image pixel data of the group and an average off-axis luminance which is dependent on the side pixel data of the group with substantially no dependence on the main image pixel data of the group; and determining from the output pixel data the signals used to drive the display panel.

According to a third aspect of the present invention, there is provided a display device comprising an apparatus according to the second aspect of the present invention.

According to a fourth aspect of the present invention, there is provided a method of creating the lookup table referred to above in relation to the first aspect of the present invention, comprising populating the lookup table with output pixel data for each of a plurality of groups of input pixel data, each group of input pixel data comprising pixel data for at least one main image pixel and pixel data for at least one spatially corresponding side image pixel, the output pixel data being known to produce an average on-axis luminance for the display device which is dependent on the main image pixel data of the group with substantially no dependence on the side image pixel data of the group and an average off-axis luminance for the display device which is dependent on the side pixel data of the group with substantially no dependence on the main image pixel data of the group.

According to a fifth aspect of the present invention, there is provided a lookup table created by a method according to the fourth aspect of the present invention.

According to a sixth aspect of the present invention there is provided a program for controlling an apparatus to perform a method according to the first or fourth aspect of the present invention or which, when loaded into an apparatus, causes the apparatus to become an apparatus or device according to the second or third aspect of the present invention.

The foregoing and other objectives, features, and advantages of the invention will be more readily understood upon consideration of the following detailed description of the invention, taken in conjunction with the accompanying drawings.

### BRIEF DESCRIPTION OF DRAWINGS

FIG. 1: is graphical representation of a previously-considered input-output data mapping used to produce a multiview effect on a liquid crystal display.

FIG. 2: is a pair of graphs showing (a) the on-axis and off-axis data value to luminance response (e.g. gamma curve) and (b) the normalised off-axis to on-axis luminance curve for a typical VAN type LCD.

FIG. 3: is graph showing the multiple normalised off-axis to on-axis luminance curves provides by a mapping of the type in FIG. 1.

FIG. 4: is a graph showing the off-axis contrast ratios as a function of on-axis luminance for the curves of FIG. 3.

FIG. 5: is a graph illustrating the existence of a “zero crosstalk region” in the envelope of available off-axis to on-axis luminance values, within which any combination of on-axis and off-axis luminance may be produced.

FIG. 6: is a graph showing the averaged on-axis luminance as a function of individual data value for two pixels of a typical VAN type LCD.

FIG. 7: is a graph showing the averaged off-axis luminance as a function of individual data value for two pixels of a typical VAN type LCD.

FIG. 8: is a set of graphs showing the measured position of the available points in the on-axis/off-axis luminance space for the 5 bit red (a), 6 bit green (b) and 5 bit red (c) channels of a colour LCD display.

FIG. 9: is a graph showing a set of target points as the intersections of a grid superimposed on a region of the space shown in FIG. 8 (c).

FIG. 10: is an illustration of the method used to find the closest available match to each target point as defined in FIG. 9.

FIG. 11: is a graph showing the result of the method of FIG. 10 as lines linking the selected points.

FIG. 12: is a graph showing the calculated error between the target value and nearest available value resulting from the selection method.

FIG. 13: is a pair of graphs showing a selected zero contrast region with (a) a large on-axis luminance range bur small off-axis luminance range and (b) a large off-axis luminance range but small off-axis luminance range.

FIG. 14: is a graph illustrating the compromise imposed by the shape of available on-axis/off-axis luminance points on the on-axis contrast and off-axis contrast of a selectable zero crosstalk region.

FIG. 15: is a graph illustrating a region which is no longer zero crosstalk, as an error region has been introduced in order to extend the available on-axis luminance range.

FIG. 16: is a graph showing a plurality of constant off-axis luminance value which have been selected throughout the available on-axis/off-axis luminance space, none of which are achievable for the whole on-axis luminance range, but from which the closest is selected in one embodiment of the invention.

FIG. 17: is a graph showing the measured position of the available points in the on-axis/off-axis luminance space for a display in which the on-axis and off-axis luminances of four neighbouring pixels rather than two is averaged to define the space.

FIG. 18: is an example of the expanded look-up table for a mapping operation in a device according to an embodiment of the present invention.

FIG. 19: is a schematic illustrating how a mapping portion of the display controller of an embodiment of the present invention may be implemented in an electronic circuit.

FIG. 20: is a schematic illustrating how a mapping portion of the display controller of an embodiment of the present invention may alternatively be implemented in an electronic circuit.

FIG. 21: is a schematic block diagram illustrating parts of a display device according to an embodiment of the present invention.

FIG. 22: is a schematic flowchart illustrating a method according to an embodiment of the present invention.

FIG. 23: is a schematic of a display described in GB2457106A, and upon which an embodiment of the present invention is based, when operating in the private mode.

FIG. 24: is a graph showing off-Axis to on-axis luminance points within the available space, selected to be the resulting outputs of the method, according to a further embodiment of the invention.

FIG. 25: is a graph showing off-Axis to on-axis luminance points within the available space, selected to be the resulting outputs of the method, according to a still further embodiment of the invention.

FIG. 26: is a graph showing off-Axis to on-axis luminance points within the available space, selected to be the resulting outputs of the method, according to a still further embodiment of the invention.

FIG. 27: is for use in illustrating a problem where the average luminance produced by a single pixel driven by different data values in alternate frames is different to the average luminance produced by the same two data values driven in a static manner.

### DESCRIPTION OF EMBODIMENTS

An embodiment of the present invention provides a means of calculating image data modifications for a liquid crystal display with a privacy function of the type outlined in GB2457106A.

In the public mode, the display would operate in a substantially unaltered manner from a standard LCD, in that for each frame of the video displayed, data constituting a single image is supplied to the display controller, the display controller then outputs a series of signal voltages and timing signals to the active-matrix array of the display, and these voltages reorient the liquid crystal director within each pixel in such a way that the required amount of light is transmitted by each pixel through the display polarisers to cause the image to be displayed.

In the private mode, the display controller outputs signal voltages which are dependent on two input images, the main image for observation by the legitimate viewer on axis, and a side image for observation by viewers not positioned in front of the display (off axis). The display controller still outputs the same quantity of signal voltage information (a voltage for each pixel in the display) as in the public mode; however those output voltages are now dependent on the image data values of two, rather than one, input images.

An embodiment of the present invention provides a means of calculating the output signal voltages such that the main image is still perceived by the on-axis viewer while, due to the data value to luminance response of the display differing on and off axis, the side image is seen by the off-axis viewer. The signal voltages are calculated such that the average off-axis luminance of neighbouring pixels is substantially independent of the average on-axis luminance of the same pixels, at least for a limited range or ranges of average on-axis and off-axis luminances.

One embodiment of the present invention provides an LCD display with a display controller modified from the standard in order to allow it to output signal voltages which are dependent on one image in the public mode and two images in the private mode. It also constitutes specific relationships between the output signal voltages and the two input images which result in the main image being observed by the on-axis viewer with image quality as close as possible to that as would be observed if the main image were displayed in the public mode, and the side image simultaneously being observed by the off-axis viewer with substantially no dependence of the average luminance of neighbouring pixels pairs to the off-axis viewer on the main image data values.

An embodiment of the present invention is based closely on the display device as set out in GB2457106A. The display device of GB2457106A will not be described in detail herein, and instead the entire content of GB2457106A is considered to be incorporated herein. Any differences between an embodiment of the present invention and the disclosure of GB2457106A will be highlighted below.

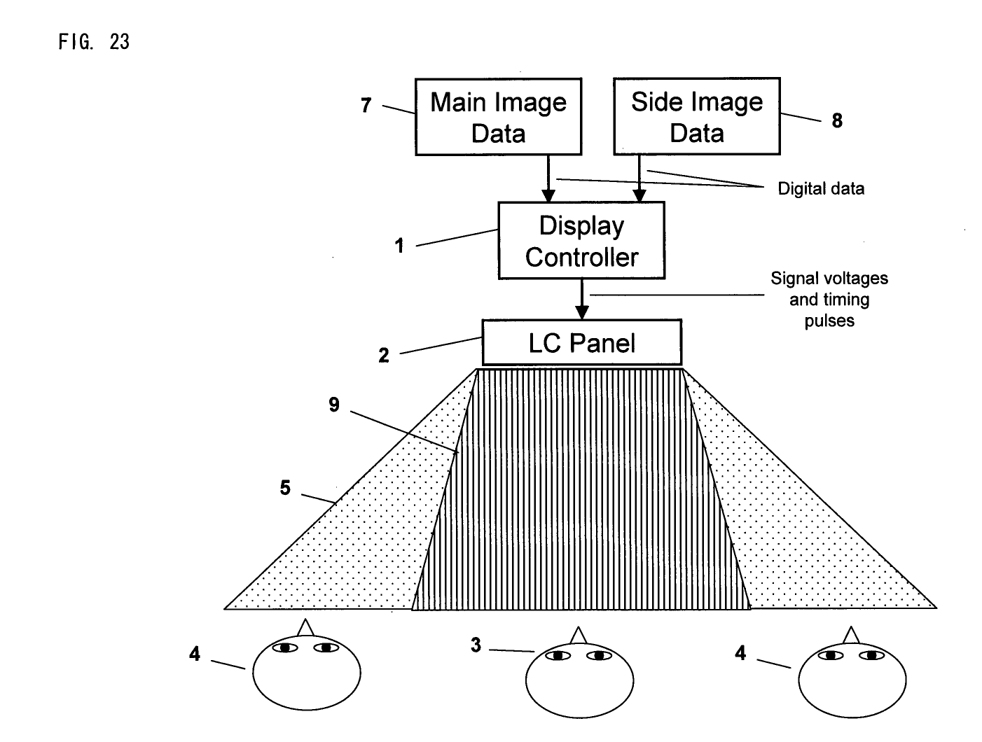

FIG. 23 illustrates a display device as described in GB2457106A and upon which an embodiment of the present invention is based. A display device is provided that comprises a liquid crystal display panel 2 for displaying an image by spatial light modulation. When the device is operating in the private mode, two image datasets are input to a display controller 1 in every frame period: main image data constituting a main image, and side image data 8 constituting a side image. The display controller 1 then outputs a set of signal data voltages, one data voltage for each pixel in the LC panel. The display controller 1 utilises an expanded look-up table (LUT) and the output signal data voltage for each pixel in the LC panel, constituting a combined image, is dependent on the data values for the corresponding pixel (in terms of spatial position in the image) in both the main 7 and side 8 images. The output data voltage for each pixel may also be dependent on a third, spatially dependent, parameter determined by the spatial position of the pixel within the display. The signal voltages from the display controller 1 cause the LC panel 2 to display a combined image to a wide cone 5 of angles. The image observed by the main viewer 3 is recognisably the main image, with minimal degradation of the main image quality. However, due to the different gamma curve characteristic of the LC panel for the off-axis viewers 4, these off-axis observers perceive the side image most prominently, which obscures and/or degrades the main image, securing the main image information to viewers within a restricted cone 9 of angles centred on the display normal.

In GB2457106A, the relationship between the input and output image data values is determined as follows:

In a first step, both the main and secondary images have their pixel data values converted to equivalent luminance values, M_{Lum}(x,y,c)=Mᵢₙ((x,y,c)^{γ}, S_{Lum}(x,y,c)=Sᵢₙ((x,y,c)^{γ}, where Mᵢₙ and Sᵢₙ are normalised to have values between zero and one, and γ is the exponent relating the data value to luminance of the display, known as the display gamma and typically having a value of 2.2.

In a second step, these luminance values of the main image are then compressed by a factor 13 and raised by an offset factor ∂: M_{cmp}(x,y,c)=β·M_{Lum}(x,y,c)+∂. Each pixel luminance value in the side image is then scaled by a factor equal to the difference between the luminance value of the corresponding pixel in the compressed main image and the edge of the range (0 or 1, whichever is closer). This difference can be obtained for any luminance value from the r.m.s. of the difference between the value and the centre of the range. Therefore the side image luminance values are scaled as S_{cmp}(x,y,c)=S_{Lum}(x,y,c)·(0.5−{square root over (M_{cmp}(x,y,c)−0.5)²)}). A minimum value greater than zero may be specified for the transformed equivalent luminance value for the side data value.

In the above, {square root over (M_{cmp}(x,y,c)−0.5)²)} is equivalent to |M_{cmp}(x,y,c)−0.5|, which is the absolute amount by which M_{cmp}(x,y,c) differs from 0.5.

In a third step, the compressed main and side images are combined, now with the addition/subtraction of luminance patterned on a sub-pixel level, for example using the spatially-varying parameter referred to previously. Colour sub-pixels are grouped into pairs with one pixel in each having its output luminance equal to the sum of the compressed main and side image luminances at that pixel, and the other having an output luminance equal to the compressed main image luminance minus the compressed side image luminance. Therefore, for the maximum value of S_{Lum}, one of the pair is always modified so as to take it either to the maximum or to the minimum of the normalized range (whichever is closer), with the other of the pair being modified in the opposite direction. The amount of such splitting, for a particular value of Mᵢₙ, is determined by the value of S_{Lum}.

As there are three colour sub-pixels in each white pixel, in order to retain the overall colour balance of the output image, the colour sub-pixels which have luminance added in the output image and those which have luminance subtracted are alternated every white pixel. This is done in both the x and y directions. It is found that this results in the optimum quality of the output image, as perceived by the on-axis viewer. The repeating unit in the pattern of combination of this method is therefore a 2×2 block of white pixels, each colour sub-pixel of which has luminance as follows:

C(x,y,R)=M_{cmp}(x,y,R)+S_{cmp}(x,y,R),

C(x,y,G)=M_{cmp}(x,y,G)−S_{cmp}(x,y,G),

C(x,y,B)=M_{cmp}(x,y,B)+S_{cmp}(x,y,B),

C(x+1,y,R)=M_{cmp}(x+1,y,R)−S_{cmp}(x+1,y,R),

C(x+1,y,G)=M_{cmp}(x+1,y,G)+S_{cmp}(x+1,y,G),

C(x+1,y,B)=M_{cmp}(x+1,y,B)−S_{cmp}(x+1,y,B),

C(x,y+1,R)=M_{cmp}(x,y+1,R)−S_{cmp}(x,y+1,R),

C(x,y+1,G)=M_{cmp}(x,y+1,G)+S_{cmp}(x,y+1,G),

C(x,y+1,B)=M_{cmp}(x,y+1,B)−S_{cmp}(x,y+1,B),

C(x+1,y+1,R)=M_{cmp}(x−1,y+1,R)+S_{cmp}(x+1,y+1,R),

C(x+1,y+1,G)=M_{cmp}(x−1,y+1,G)−S_{cmp}(x+1,y+1,G),

C(x+1,y+1,B)=M_{cmp}(x−1,y+1,B)+S_{cmp}(x+1,y+1,B),

The equivalent image data level for the combined image can be found by applying the inverse of the gamma power operation: C_{data}(x,y,c)=C(x,y,c)^{1/γ}. The output voltage in the expanded LUT of the display control electronics will then be equal to the voltage corresponding to this equivalent data level in the public mode off LUT entries.

PCT/JP2008/068324 (published as WO 2009/110128 on 11 Sep. 2009), which is based on GB2457106A, also discloses a method to obtain an accurate colour side image effect, in which the side image of 2 bit per colour (6 bit total) depth is input to the control electronics, and four pairs of output values are included in the expanded LUT for every main image data value, the output value pairs being calculated according to the following method:

C(x,y,c)=M_{cmp}(x,y,c)±1×S_{cmpmax}(x,y,c), for Sᵢₙ=0

C(x,y,c)=M_{cmp}(x,y,c)±0.98×S_{cmpmax}(x,y,c), for Sᵢₙ=1

C(x,y,c)=M_{cmp}(x,y,c)±0.85×S_{cmpmax}(x,y,c), for Sᵢₙ=2

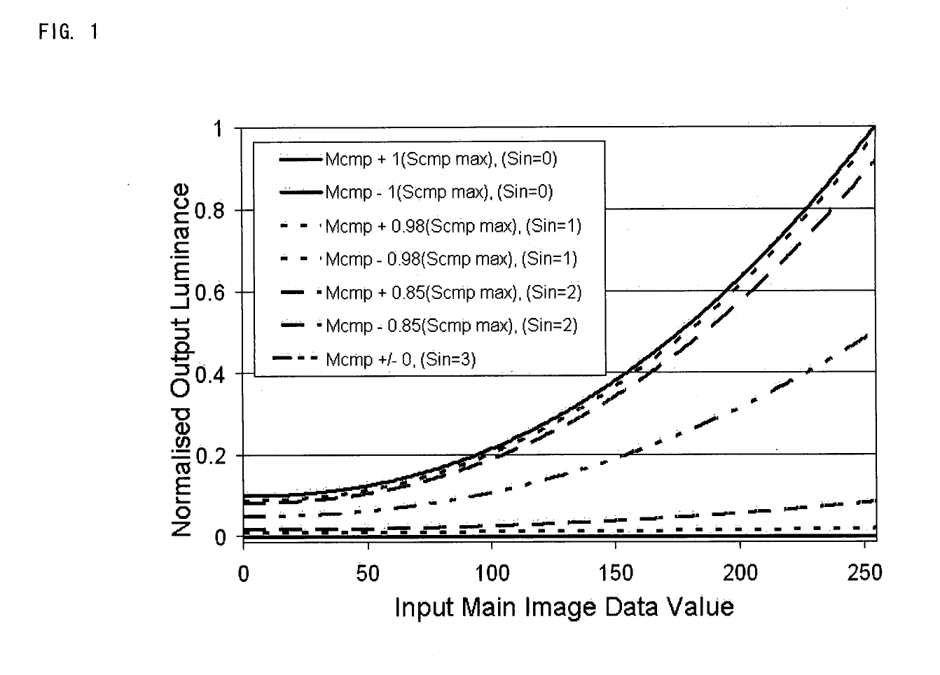

C(x,y,c)=M_{cmp}(x,y,c)±0, for Sᵢₙ=0

where “S_{cmp max}” is the maximum available compressed side image value, calculated as previously, i.e. for S_{cmp max}=|M_{cmp}(x,y,c)−0.5|. The graphical representation of values calculated in this way is shown in FIG. 1.

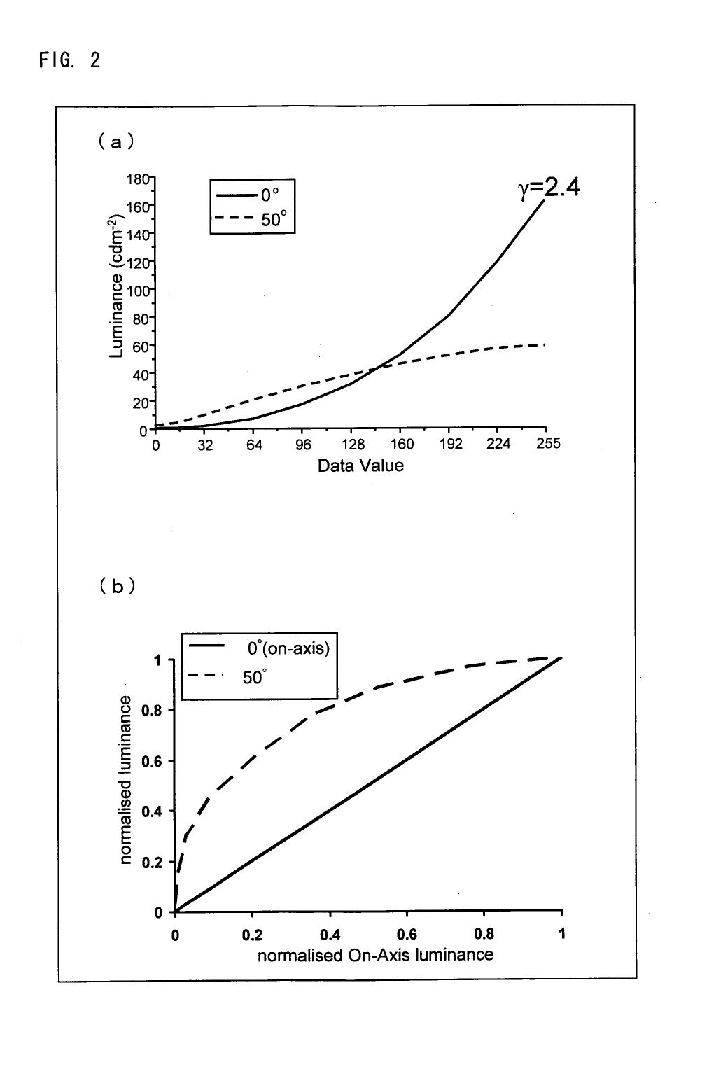

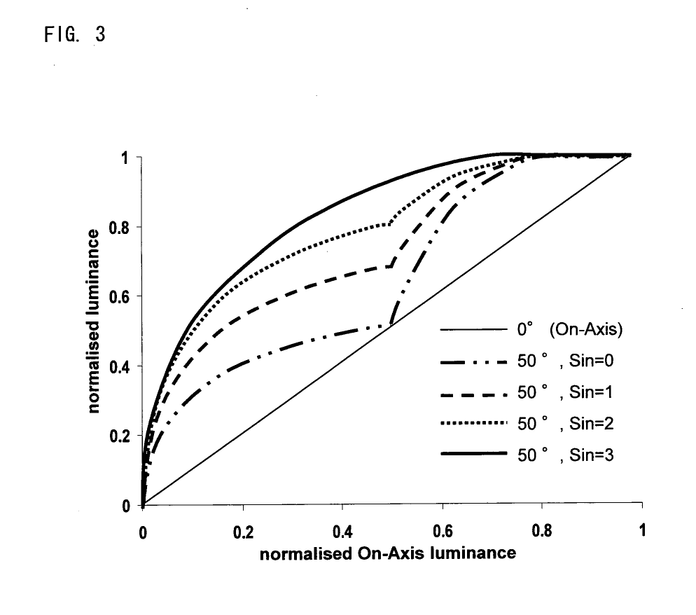

FIG. 2 (a) shows a typical data value to luminance response (gamma curve), on-axis and at a viewing inclination of 50° off-axis, for an MVA or ASV type display. If these data values are normalised and plotted against the normalised On-Axis luminance, the result is as shown in FIG. 2(b). When the above method is applied to a display with this characteristic, the resulting off-axis luminance as a function of on-axis luminance for each side image value is shown in FIG. 3. Note the full range of available On-Axis luminance values is shown in FIG. 3, as would be attainable with no main image compression (β=1, ∂=0).

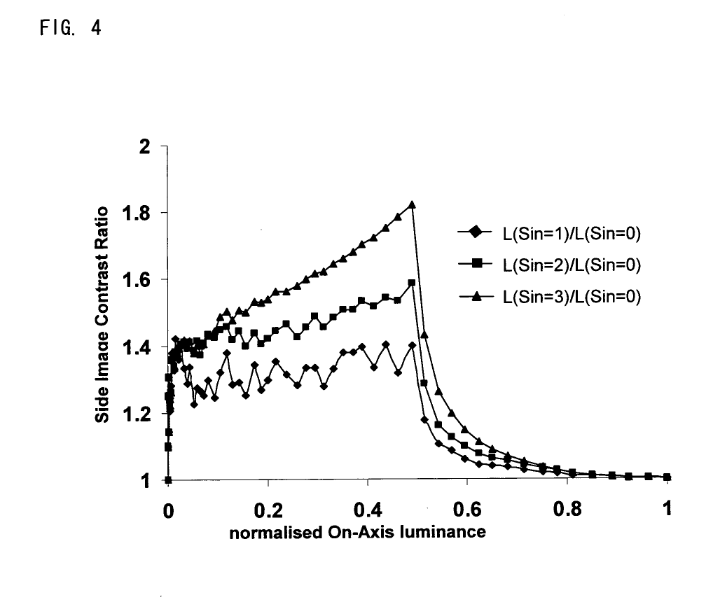

The above previously-considered method of calculation has four possible side image values: Sᵢₙ=0, 1, 2 and 3. As can be seen in FIG. 3, when Sᵢₙ=0, maximum splitting is used for each main image data value, resulting in the lowest overall luminance off-axis across the range of on-axis luminances. When Sᵢₙ=3, no splitting is used, resulting in the highest overall luminance off-axis across the range of on-axis luminances. The suggested values of 0.98 and 0.85 times the maximum available change to the M_{cmp} data for the mid-range side image values Sᵢₙ=1 and 2 respectively has been found to produce approximately even increments in the off-axis luminance for the different input side image values. This means the different side image states retain a good degree of proportionality relative to each other over the whole on-axis luminance range. This is further illustrated in FIG. 4 which shows the relative luminance of the different side image states at 50° viewing inclination as a function of on-axis luminance as measured on an ASV type LCD operating in the manner described above. In other words, FIG. 4 shows the off axis luminance curves from FIG. 3 for Sᵢₙ=3, 2 and 1, divided by the off-axis luminance curve for Sᵢₙ=0 from FIG. 3, i.e. the contrast ratio of the different side image states, over all on-axis luminances. It shows that for most of the on-axis luminance range, regions where Sᵢₙ=1 will be roughly 1.3×brighter than those with Sᵢₙ=0, and regions with Sᵢₙ=2 will be roughly 1.5×brighter than those with Sᵢₙ=0, and regions with Sᵢₙ=3 will be as bright as possible (up to 1.8×brighter than those with Sᵢₙ=0).

The previously-considered method has the drawback that, although for any given main image input value the different side image states are evenly incremented between the maximum and minimum available off-axis luminance levels, as the main image value changes, so does the off-axis luminance, even if the side image value remains constant. This is apparent from a consideration of any of the Sᵢₙ=0 to 3 traces of FIG. 3: moving along the line from left to right is caused by an increase in the main image data value (since the effect of the side image data values, to raise/lower the luminance of adjacent pixels, is designed to cancel out on average). However, it is readily apparent that as the main image value increases, the off-axis luminance changes considerably even when the side image value remains constant (i.e. moving along one of the traces).

This residual influence of the main image data value on the off-axis luminance results in “leakage” of main image information through the intended side image (referred to herein as “crosstalk”). It is desirable to eliminate or at least reduce this type of crosstalk.

In a preferred embodiment of this invention, this crosstalk is eliminated at least to some extent by compressing the main and side images to lie within luminance ranges within which it is possible to have a pair of neighbouring pixels with any average off-axis luminance and any average on-axis luminance.

The range of average off-axis luminances for a pair of pixels with any given average on-axis luminance is bounded by the state in which the on-axis luminances of the individual pixels are the same, and the state in which they are maximally different, i.e. the side image=3 and side image=0 output values as calculated by the method described above. The envelope of available average off-axis luminances is thereby given by the Sᵢₙ=0 and Sᵢₙ=3 traces of FIG. 3. The Sᵢₙ=0 and Sᵢₙ=3 traces define an envelope of possible pairs of on-axis and off-axis values.

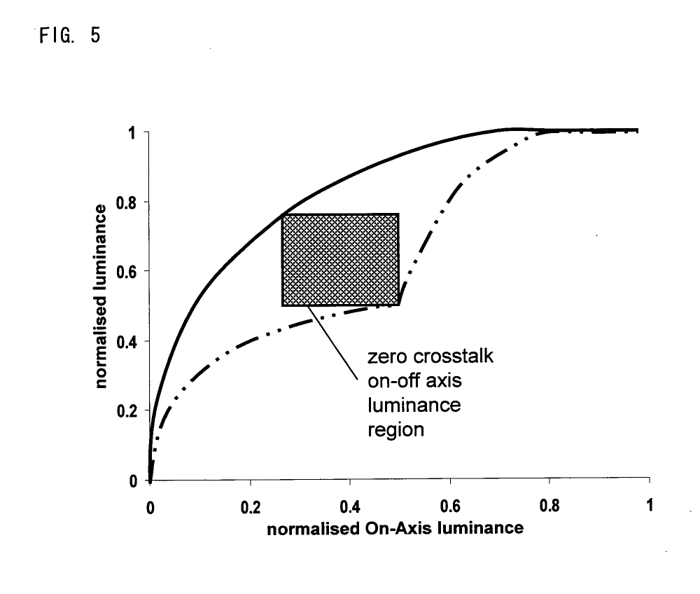

As shown in FIG. 5, any region with edges of constant on-axis and off-axis and side image luminance (i.e. an oblong with horizontal and vertical edges) which fits within this envelope contains on-axis and off-axis luminance combinations which can be achieved by averaging the individual on-axis and off-axis luminance values produced by a pair of neighbouring pixels. Where the density of available on-axis and off-axis luminance values within the ranges defined by such a region is sufficient, individual data values for a pair of neighbouring pixels (or the pair of choices available for a single pixel, selected by use of the spatially-varying spatial parameter) can be chosen so as to produce substantially any average off-axis luminance value and any average on-axis luminance value within the ranges simultaneously.

This is achieved by choosing an appropriate amount of splitting, from 0×S_{cmp max} to 1×S_{cmp max}, for each average on-axis luminance level so as to maintain a substantially flat average off-axis level, at least where possible within the constraints of the envelope mentioned above. In doing so, it is possible to display main and side images independent of each other, and therefore with substantially zero crosstalk. A method of achieving this according to an embodiment of the present invention will now be discussed.

As with the previously-considered method, a display device embodying the present invention performs a mapping from main image pixel data and side image pixel data to signal voltages (or to further data values which are then used to determine the signal voltages). The apparatus of FIG. 23 therefore also applies to an embodiment of the present invention; it is the mapping (which may take the form of a LUT) which is different to the previous method in order to reduce the effect of crosstalk.

In one approach to determining an appropriate mapping for use in an embodiment of the present invention, the data-value to luminance response (gamma curve) of the LCD is measured, both on-axis and at the off-axis viewing angle at which the side image is intended to be viewed with zero crosstalk, for each colour component individually. The luminance resulting from every available input data level of each colour may be measured individually, or the luminance may be measured at regular intervals of input data, and the luminance of the intermediate points interpolated. The luminance values are then normalised, and the average luminance resulting from two pixels calculated from these results for every available combination of individual data values on the two pixels.

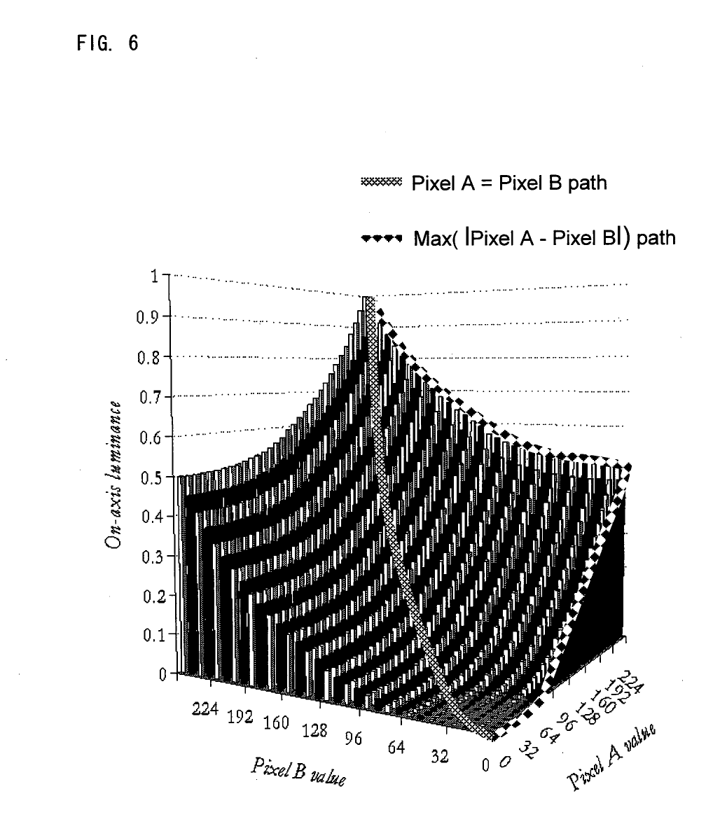

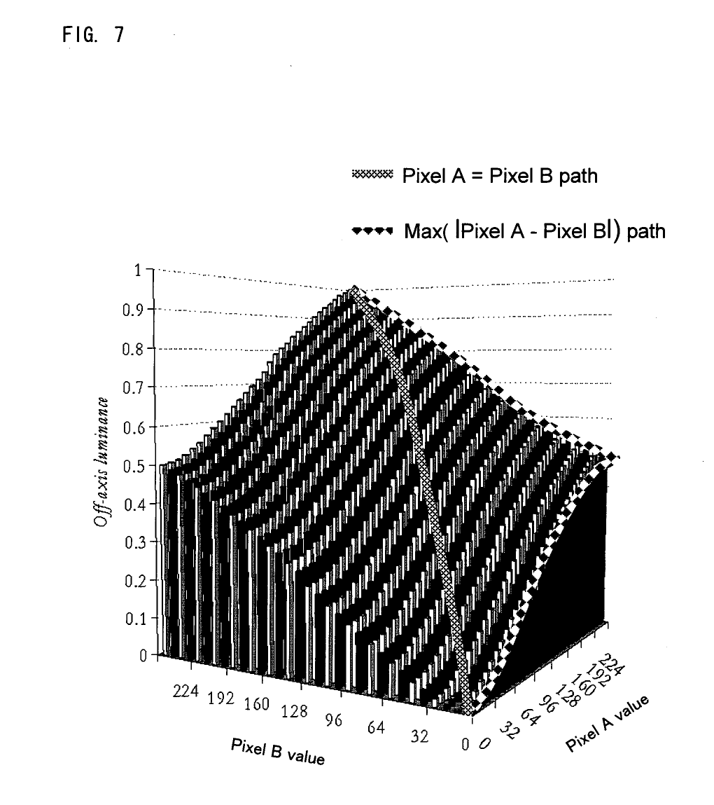

Plots of these average luminances for all combinations of pixel values on a single colour channel, calculated from the measured on and off-axis luminances of an ASV type LCD panel are shown in FIG. 6 (normalised on-axis luminance) and FIG. 7 (normalised off-axis luminance). For a display with 6 bit per colour bit-depth, this results in 2080 combinations of individual pixel values.

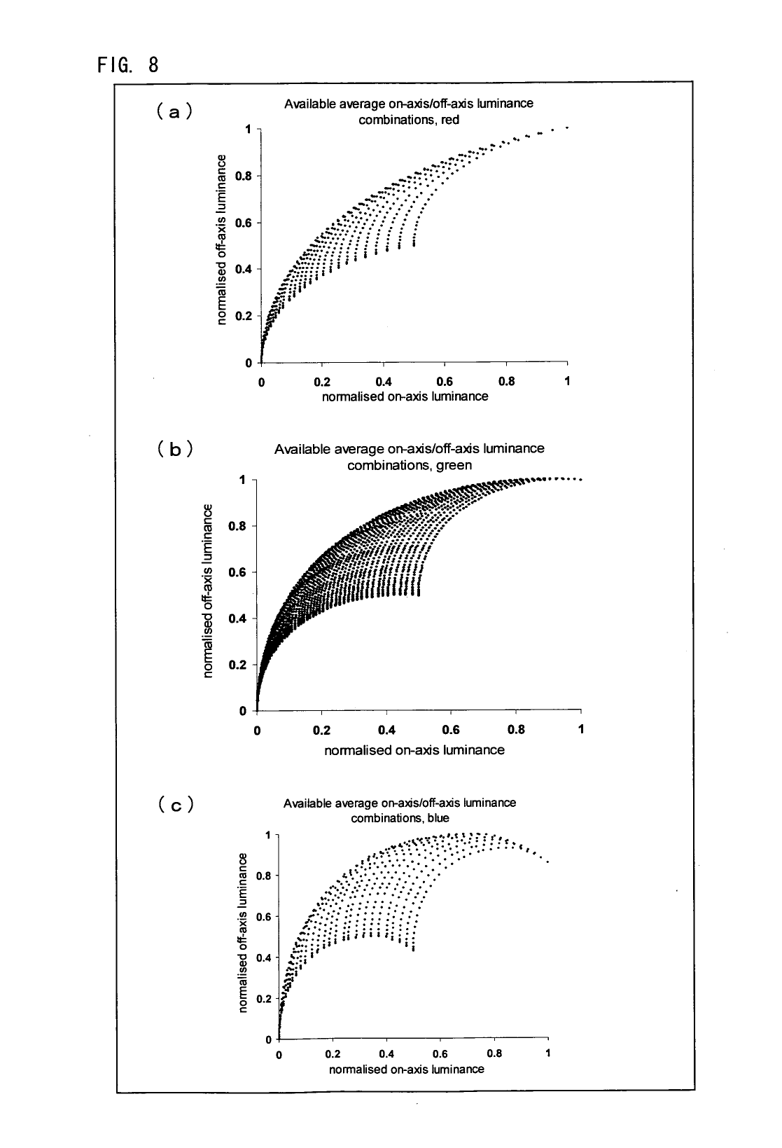

Normalised off-axis luminance can then be plotted against the normalised on-axis luminance for all of these points. The available points as measured for an ASV type display with 5 bit colour depth for the red and blue channels, and 6 bit colour depth for the green channel are shown in FIGS. 8(a) to (c) for the red, green and blue channels respectively. The range of available average on and off axis luminance values for a pair of pixels can be seen to populate the envelope of available values between the Sᵢₙ=0 and Sᵢₙ=3 traces of FIG. 3.

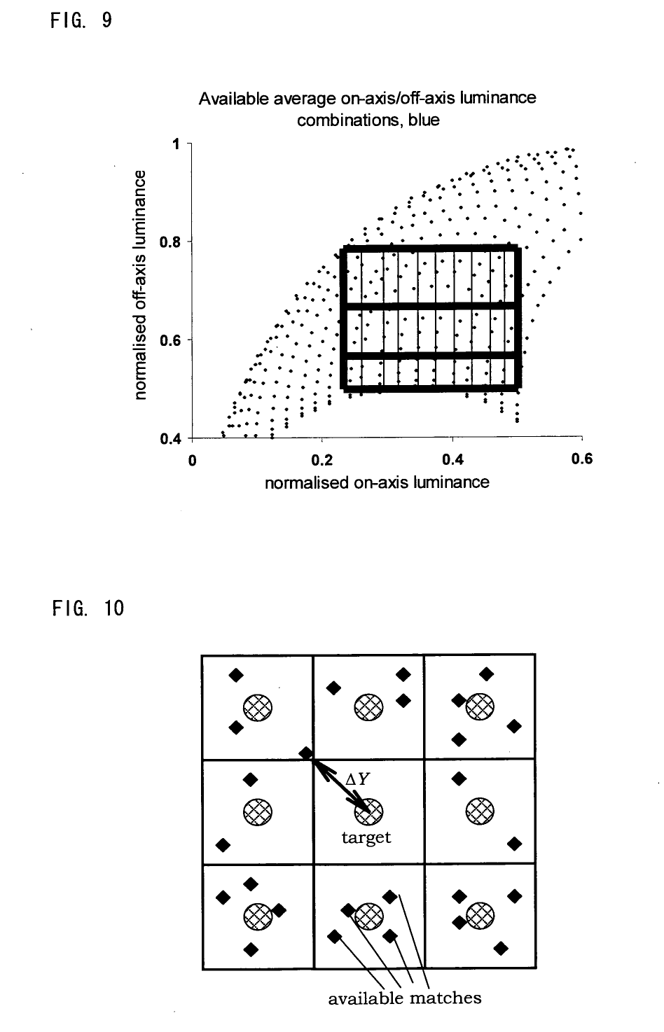

Once these available on-axis to off-axis luminance points have been determined, a rectangular zero crosstalk region can be defined within the area of available points, and a grid of intersecting vertical lines (of desired on-axis luminance values) and horizontal lines (of desired off-axis luminance values) may be defined within the zero crosstalk region, as illustrated in FIG. 9 for the blue channel.

Each intersection of this grid is then a target off-axis/on-axis luminance point, and the nearest actual available off-axis/on-axis luminance point to each target point can be selected. Based on the analysis represented in FIGS. 6 and 7, the individual pixel data values which on average produce the selected on-axis and off-axis luminance values are then noted and stored in the LUT used to perform the mapping from input pixel values to signal voltages.

This selection of the nearest actual available off-axis/on-axis luminance point to each target point is illustrated in FIG. 10, and may be performed by a program which analyses the available points and selects the one with the minimum combined luminance error ΔY from each target point. In selecting the nearest available point, different weightings may be applied to the on-axis and off-axis luminance error, depending if it is deemed more important to minimize the image crosstalk in one particular viewing direction over the other.

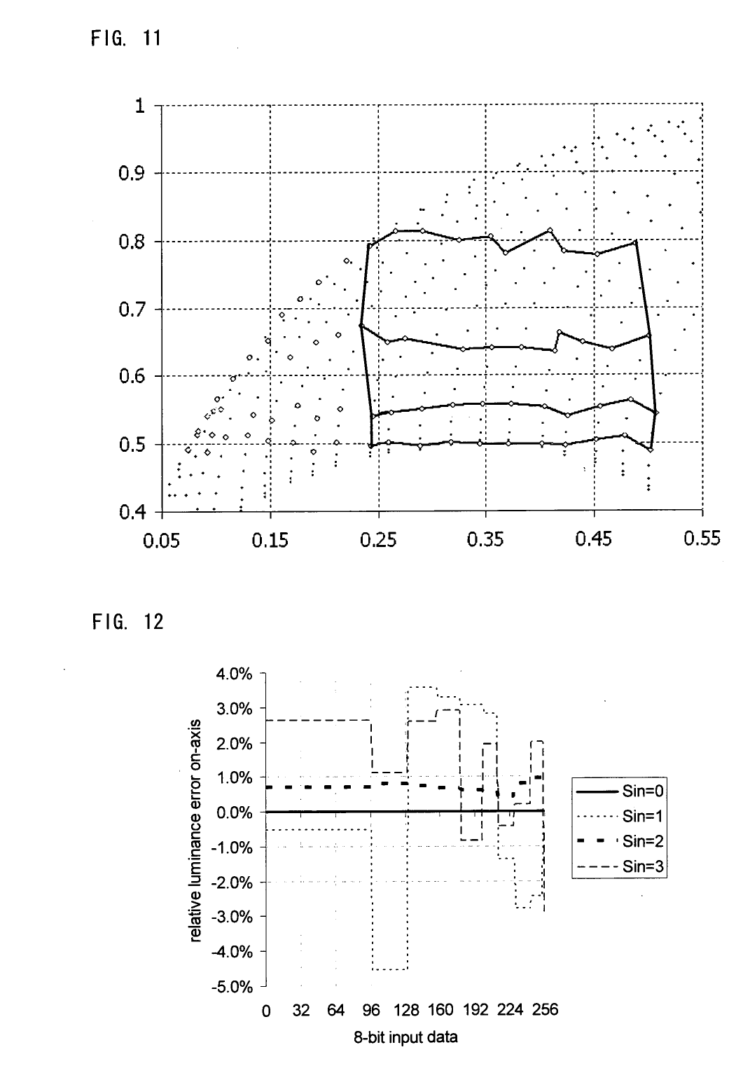

FIG. 11 shows the selected on-axis/off-axis luminance points selected by such a program according to the target grid shown in FIG. 9 for the 5 bit greylevel depth blue channel of a LCD. As can be seen, for a relatively low bit depth display such as this, it is impossible to select values without some error occurring, and the on-axis luminance component of this error is plotted for each side image value in FIG. 12. The program used to illustrate the method in this instance identifies every on-axis luminance level within a given error of the defined on-axis luminance range (0.25-0.5) produced by incrementing the data value of one of the pixel pair by one to define the number and position of vertical lines of the grid of FIG. 9, then selects the nearest available point for each of these increments on the horizontal line defined by the low edge of the target off-axis luminance range and defines this as a target on-axis luminance value. The Sᵢₙ=0 points therefore have an on-axis luminance error of zero by definition.

In order to obtain optimum reproduction of the intended images to the main and side viewer, the error values shown in FIG. 12 ought to be minimized, and this can be done by fine adjustment of the target off-axis luminance levels to coincide with off-axis luminance levels which many available points lie close to. For higher bit-depth displays, the density of available points in the off-axis/on-axis luminance space is much greater, so fine tuning of the target levels is less necessary.

As mentioned above, the apparatus of FIG. 23 applies to an embodiment of the present invention, with the display controller 1 being adapted to perform a predetermined mapping from main image data 7 and side image data 8 to signal voltages to eliminate or at least reduce the dependence of the off-axis luminance on the main image data 7.

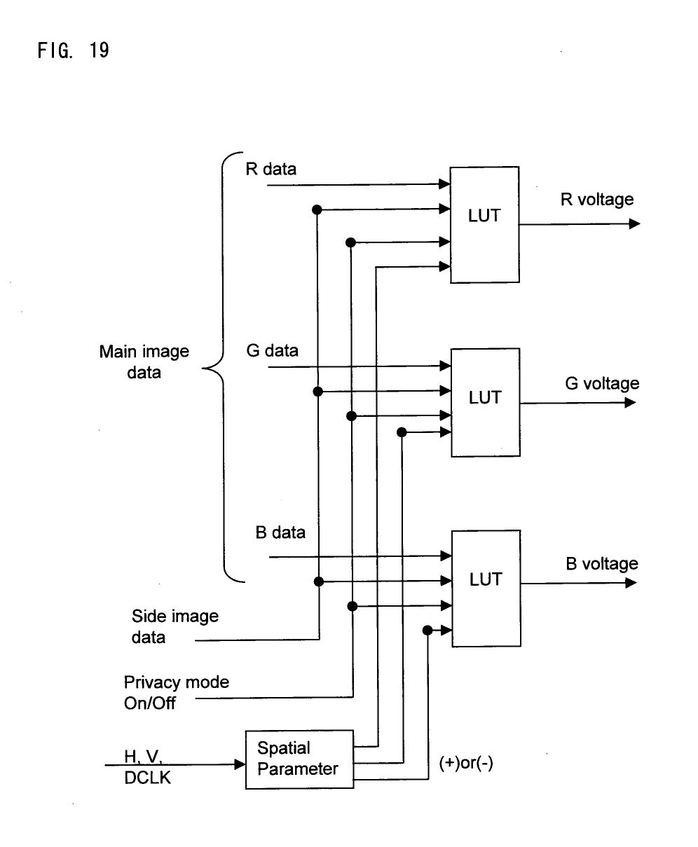

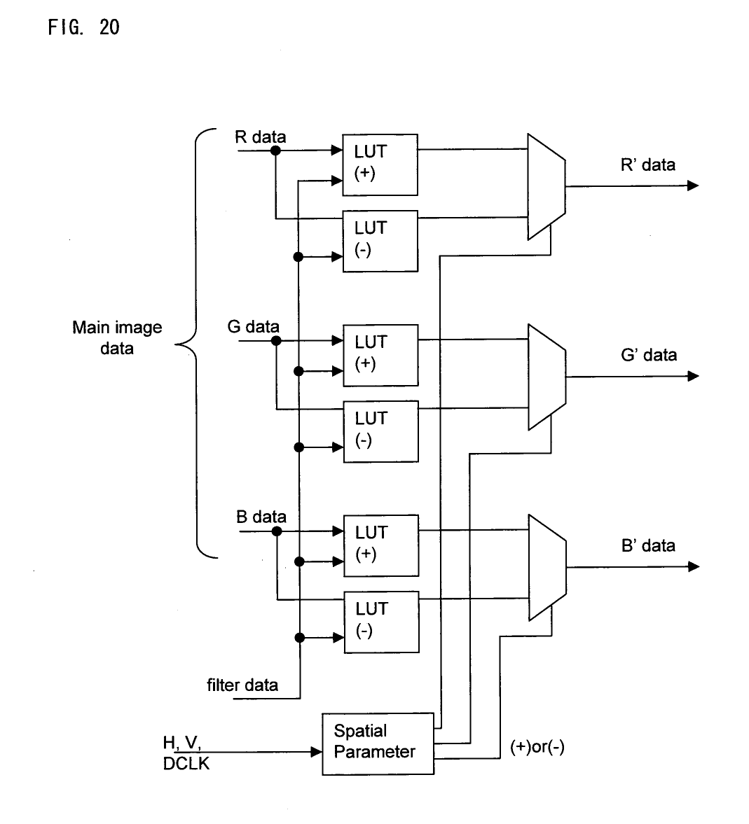

The general steps performed by a display device embodying the present invention when main image data 7 and side image data 8 are input to the display controller are as described in GB2457106A; it is the actual mapping that is different. The main image data 7 and side image data 8 are used as indexes to a LUT, along with the spatial “flag” parameter which determines whether that pixel in the display is one having its output made brighter or darker, to retrieve an output data value from the LUT. Such a LUT is illustrated schematically in FIG. 18 (which is the same as FIG. 4 of GB2457106A; because the illustrated LUT is schematic in nature without setting out any particular mapping, it applies equally to the present embodiment). FIGS. 19 and 20 show possible implementations of lookup circuitry in the display controller 1 (these two Figures are the same as FIGS. 6 and 7 respectively of GB2457106A; again, these Figures are applicable to the present embodiment because they show suitable lookup circuitry without specifying details of what is in the lookup tables themselves, i.e. without specifying the actual mapping).

The format of the expanded look-up table required for operation of the device in the manner described is shown in FIG. 18. As can be seen, an output voltage is supplied for all combinations of main image pixel data value, side image pixel data value, privacy mode on/off, and spatial flag parameter. The whole of the look-up table is not shown, as the main image will typically have 8 bit data, so 256 possible values, for each of which there are five possible combinations of the above parameters (if privacy mode is off, there is no need to refer to the side image and spatial flag parameter values). It should be noted that the embodiment is not limited to 1 bit data for the side image, and that main and side images of any colour bit-depth can be accommodated by the device; increasing the colour-bit depth will simply require an increase in the amount of memory required.

An example circuit diagram illustrating how the added functionality provided by the expanded LUT of FIG. 18 may be implemented in the display controller electronics is shown in FIG. 19. FIG. 19 shows mapping circuitry having respective inputs for receiving the main image data values and the secondary data values (side image data values and spatial flag parameter values), circuitry (LUT) for looking up a stored value in dependence upon the input data values, and an output for outputting the stored value (R voltage, G voltage, B voltage), the signal voltage for the image element being determined in dependence upon the output value (in FIG. 19 the signal voltage is equal to the output value, though this need not be so). The circuit shows the control electronics for a single white pixel, with red, green and blue sub-pixels. It should be noted that although this diagram assumes monochromatic side image data, and therefore the input value to the R, G and B sub-pixels is the same, this is not necessarily the case. Also, it can be seen from FIG. 19 that the separation of the pixels into groups according to the spatial parameter in these examples is done by means of an output from the spatial parameter controller to each sub-pixel LUT. This allows dynamic reconfiguration of the spatial groupings which may be advantageous, either to reverse the polarity of the groupings in sequential time frames, or to alter the spatial arrangement of the groupings in the image for different applications. It is also the case that if the patterning of spatial groupings in the image is required to be fixed, only a single spatial parameter output would be required and the selection of groupings could be hardwired into the control electronics by means of the presence or not of an inverter on the input of the spatial parameter data line into each sub-pixel's LUT.

FIG. 20 illustrates a further example of a potential implementation of the modified control electronics of the device. This arrangement is a simplified equivalent of the more general circuit in FIG. 19, for the special case in which the mapping of input data to output voltage is the same in the public mode and in the private mode when the side image data value is 0. The public mode image is therefore equivalent to a private mode image with a uniform side image of data value 0 pixels, and the need for a separate Private Mode On/Off input is removed.

The examples shown in FIG. 19 and FIG. 20 both include circuitry for determining the spatial flag parameter value from spatial information relating to the image element, where in these examples the spatial information comprises horizontal and vertical image coordinates associated with the image element, represented by the horizontal and vertical signals H and V respectively. The DCLK signal shown in FIGS. 19 and 20 is a timing signal.

It should be noted that again that, although FIGS. 18 to 20 are based respectively on FIGS. 4, 6 and 7 of GB2457106A, the actual mapping encapsulated in the LUTs of GB2457106A is different to that in the present embodiment.

In the present example, where the main image has data values in the range 0 to 255 and the side image has data values in the range 0 to 3, the LUT has 256×4×2 entries (two possible outputs, one brighter and one darker, for every combination of main and side image value), one of which is selected for each pixel of the display. Of course, this would change if the main and side images have bit-depths other 8 bits and 2 bits per colour respectively, or where some form of pre-scaling of the data is performed before reaching the LUT (see below).

The output from the LUT can be an equivalent data value, which is then input to the standard display controller common to any LCD, whereby the digital data value is converted to an analogue signal voltage to be directed to the relevant pixel in the display. These functions may be combined though, with the LUT combining both steps, and outputting the signal voltage directly. As in GB2457106A, in the present embodiment the pixels are operated on one at a time, rather than in pairs, and as a result it must be noted that imperfect spatial averaging will occur when two neighbouring pixels have significantly different main image data values. However, it would also be possible to operate on pairs in order to eliminate this, although such a method would likely be more computationally demanding and/or require more storage. One such possibility for operating on pairs would be to input the main and side image data values for two pixels to the data modification calculation process. The output data values for each pixel could be then produced in the usual manner, and then compared to each other and the input data values. In this way, the degree of luminance modification being applied to each pixel could be determined and if an imbalance exists, due to the pixels in the pair having significantly different main image data values or any other reason, the magnitude of luminance modification applied to both pixels could be limited to the smaller of the two intended modifications. Another such possibility would be to take the average luminance value corresponding to the combination of main image data values of the two pixels being considered, and input the data value corresponding to this average luminance to the existing LUT for both pixels. This would ensure the output data values/signal voltages that result would have produce the same average luminance but would decrease the effective resolution of the display. This resolution loss may be mitigated by, rather than having the spatial flag parameter, and therefore the choice of which of the two output values is applied to each of the two input pixels, fixed spatially in terms of pixel position, have it determined by the relative data values of the two input pixels. If the spatial flag parameter which results in a pixel having its data value increased was always applied to the pixel of the pair with the higher data value of the two being input to the modification process, and vice versa, this would ensure that the output image more closely resembled the input image on the local scale.

To illustrate operation of a display device embodying the present invention, consider a mapping for use by the display controller 1 that is based on the calculation method described with reference to FIGS. 9 and 11, where there are 11 available on-axis values, and 4 available off-axis values.

Consider that the main image data 7 of FIG. 23 has 256 levels, from 0 to 255, and the side image data 8 has 4 levels, from 0 to 3. One possibility is first to compress the main and side image in data terms, to however many levels are available for each of the images. Before inputting to the LUT, therefore, the main image has to be compressed to have values from 0 to 10, and the side image to have values from 0 to 3. In this example, therefore, no compression of the side image is required, but compression of the main image is. How one compresses the main and side images (which initially may both have data values form 0 to 255) to this bit-depth is not of importance within the context of the present invention, but it is may be done taking into account the display gamma curve (i.e. one could compress in luminance terms).

These new relative data values can then be input straight to the LUT. In the present example, the LUT only has eleven main image values and four side image values available because this was considered a sensible number of values to have based on the density of available points within the “zero crosstalk box” in the diagram of FIG. 11. From FIG. 8(b) it can be seen that the green channel has greater bit-depth, so one could specify more available values in this case.

Rather than perform a separate compression step before inputting the data to the LUT, the compression could effectively be performed as part of the lookup. In this alternative, the LUT would hold output values for all combinations of main image data values from 0 to 255 and side image data values from 0 to 3, for example with certain entries repeated.

In either of the above cases, the LUT can return either a new data value, or a signal voltage, as discussed. As before, the mapping holds (or enables the determination of) a pair of data values, these values being the ones which will, when averaged, provide the desired on-axis and off-axis luminance. Which individual data value of the pair is returned for the individual pixel being operated on is dependent on the spatial “flag” parameter, which is also input to the LUT, which for example specifies whether the current pixel is an even or odd one, i.e. is one having its value made bigger or smaller.

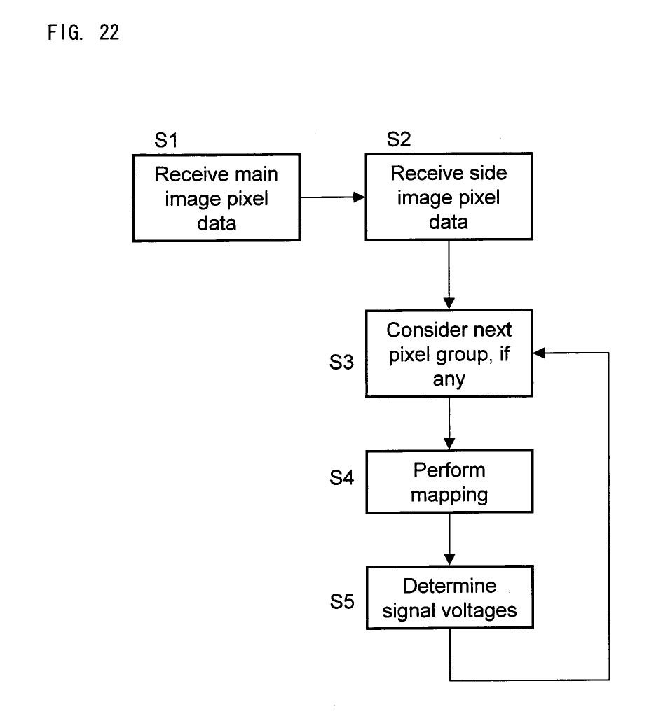

A method carried out by the display controller 1 according to an embodiment of the present invention is summarised in the flowchart of FIG. 22. In step S1, the display controller 1 receives main image pixel data 7 representing a main image, and receives side image pixel data 8 representing a side image in step S2. For each of a plurality of pixel groups, where each pixel group comprises at least one pixel of the main image pixel data and at least one spatially corresponding pixel of the side image pixel data, a loop is performed from steps S3 to S5. Each pixel group may comprise a single main image pixel and a single spatially corresponding side image pixel. In step S3, the next pixel group of the plurality is considered, if any. In step S4, a predetermined mapping is performed by the display controller 1 using the pixel data of the pixel group under consideration as input. The mapping is arranged to hold, or at least be capable of determining, output pixel data for the input pixel data which is known in advance to produce an average on-axis luminance which is dependent on the main image pixel data of the group with substantially no dependence on the side image pixel data of the group and an average off-axis luminance which is dependent on the side pixel data of the group with substantially no dependence on the main image pixel data of the group. The mapping may be performed using a lookup table which is pre-populated with data. In step S5, the signal voltages to be applied to the panel for the main image pixels of the group are then determined from the output pixel data. It will be appreciated that each pixel may be a composite pixel comprising a plurality of colour component sub pixels, and the method may be applied in turn to each of the colour component sub pixels.

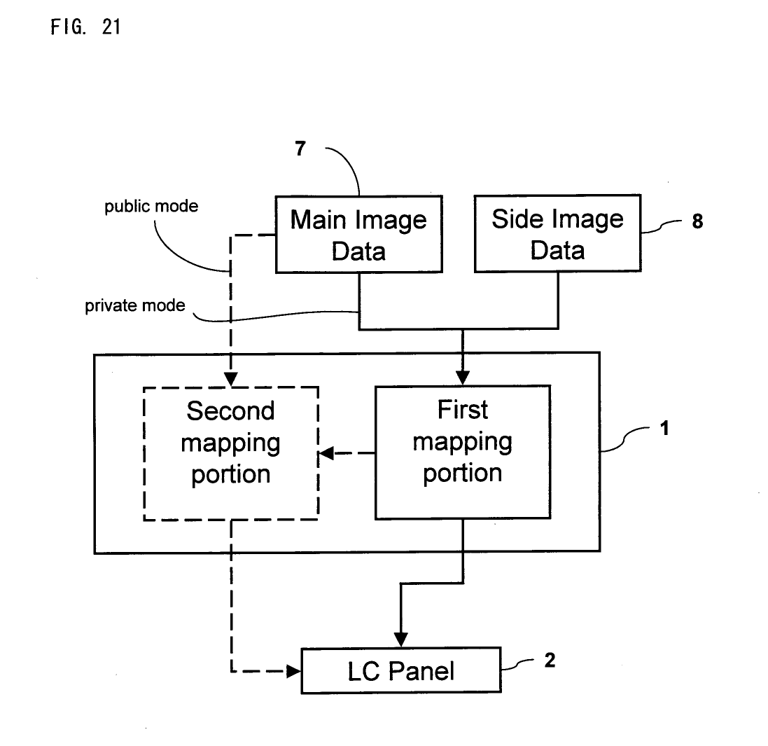

As mentioned above, the output pixel data could directly represent the signal voltages to be applied to the panel (i.e. the signals used to drive the display panel), or a further mapping could be performed to derive the signal voltages from the output pixel data. This is represented in the schematic block diagram of FIG. 21, which shows that the signal controller 1 of FIG. 23 can have two mapping portions M1 and M2. The first mapping portion M1 performs the mapping characteristic of an embodiment of the present invention, as set out above, the mapping holding output pixel data which is known in advance to produce an average off-axis luminance which is dependent on the side pixel data of the group with substantially no dependence on the main image pixel data of the group. As shown by the solid lines in FIG. 21, where the output pixel data directly represents the signal voltages to be applied to the panel 2, the output pixel data (signal voltages) can be delivered straight to the panel 2. Alternatively, as shown by the dotted lines and outlines in FIG. 21, the display device could comprise a second mapping portion M2 which is arranged to map the main image data 7 to signal voltages when the display device is operating in the public mode purely on the main image data 7. When operating in the private mode according to a method embodying the present invention, the output pixel data from the first mapping portion M1 could be sent to the second mapping portion M2 for mapping to the signal voltages to be applied to the display panel.

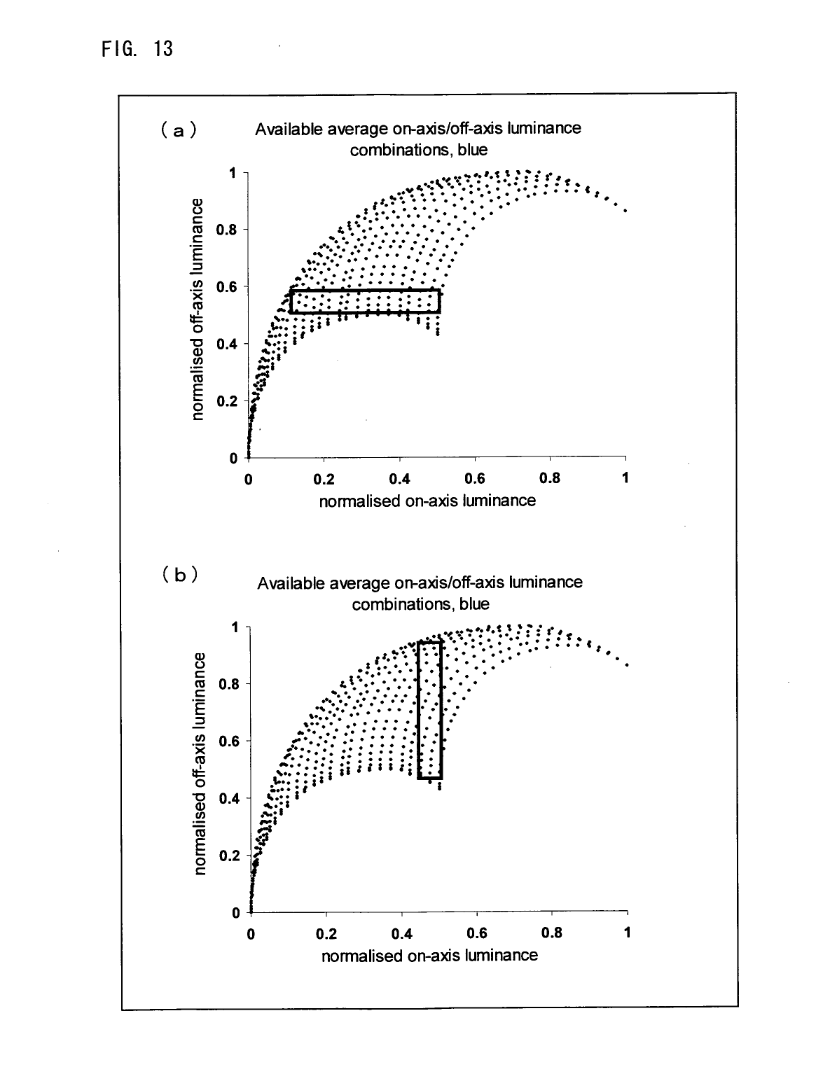

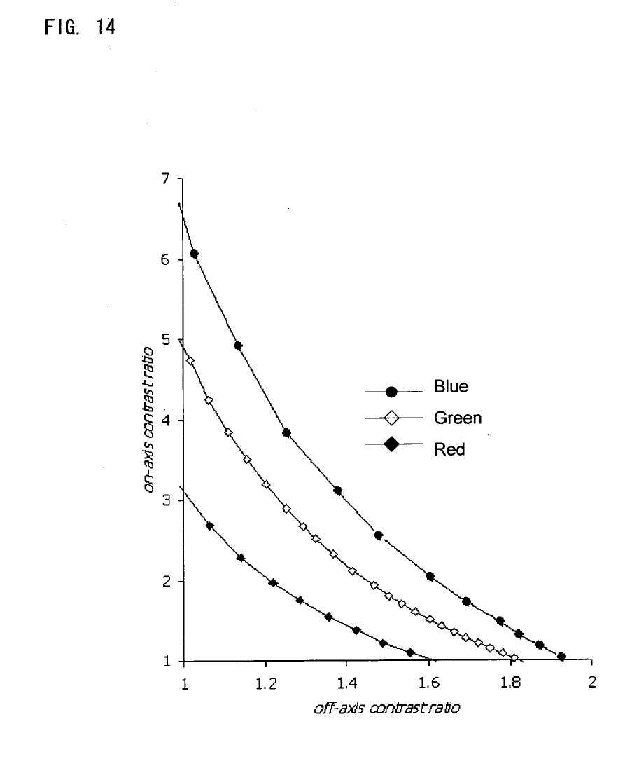

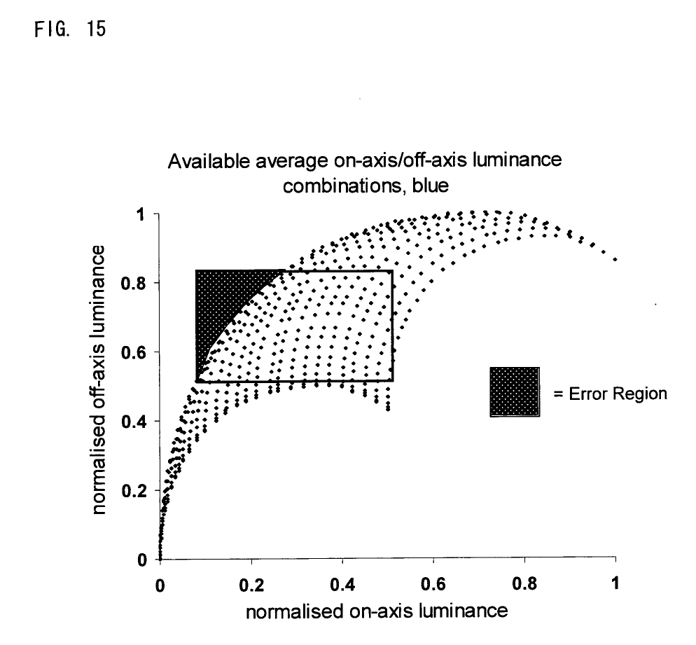

The size and shape of the zero crosstalk region may be selected according to the relative importance of available contrast in the main and side images. Due to the shape of the available on-axis/off-axis luminance envelope, there is inherently a compromise between the contrast of the main and side images. FIG. 13 shows two possible zero contrast regions chosen for high on-axis (main image) contrast (a) and high off-axis (side image) contrast (b). The shape of the available on-axis/off-axis luminance envelope determines the nature of the contrast trade-off and this is shown in FIG. 14.

In order to improve the available contrast for the main and/or side images, at the expense of some crosstalk, the region in which on-axis to off-axis luminance values are sought may be extended beyond the available envelope, as shown in FIG. 15. In this case, the nearest on-axis/off-axis luminance match is still found for each target point as previously described, but now target points which lie well outside the available envelope (in the “Error Region” as indicated on the figure, will generate large error and will result in visibility of these points to the unintended viewer. This may be acceptable however, in order to provide the resulting image contrast increase.

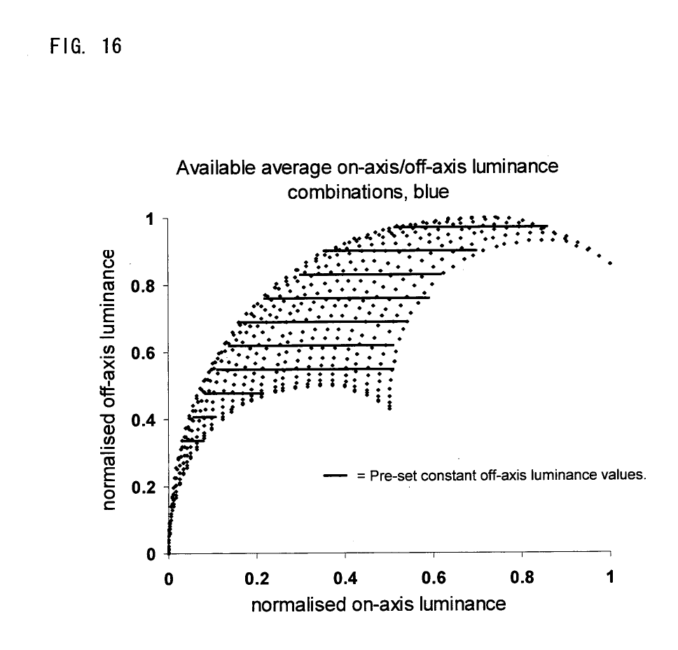

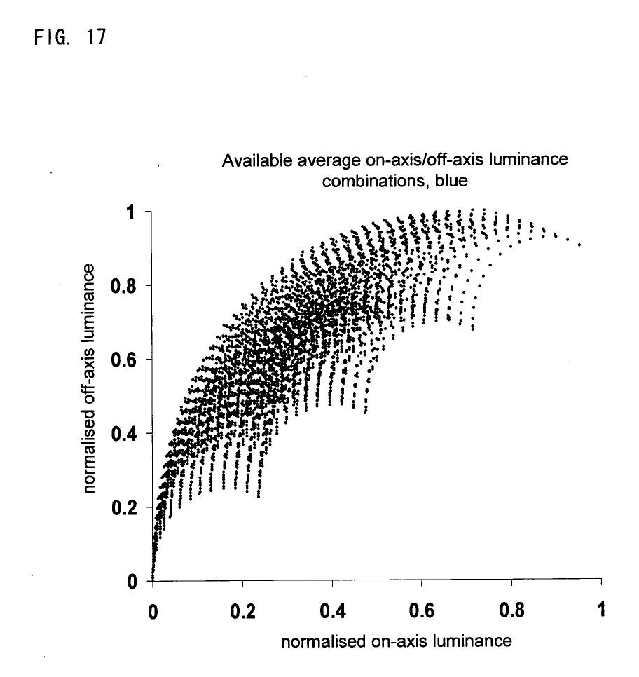

As an extension of the alternative shown in FIG. 15, those points from the population of available off-axis to on-axis luminance points which correspond to one of a set of constant off-axis luminance values at regular off-axis luminance steps are selected, for the whole range of on-axis luminance values, as illustrated in FIG. 16. Thereby, rather than restricting the main and side images have pixels with luminance values only within a restricted range in order to allow zero crosstalk, an increased luminance range for the main and side images may be used at the expense of increased crosstalk where that crosstalk is unavoidable. However, for main and side images which happen to complement each other and produce combined target off-axis/on-axis luminance values which mostly sit within the envelope, acceptable overall crosstalk may be achieved with much higher main and side image contrast than the heavily compressed zero crosstalk method of the preferred embodiment.

In order to preserve main and side image contrast to the greatest degree possible for a given amount of crosstalk, rather than always applying the amount of compression to each image required to ensure any target on-axis and off-axis would fall within the zero crosstalk box, as shown in FIG. 5, the mapping step could be preceded by a main and side image analysis processing step in which the degree of correlation between the main and side images is assessed, and the minimum amount of compression required to ensure the two images can be reproduced to their intended viewers with an acceptably low crosstalk is determined. This optimum compression could then be applied to the two input images before they are input to the LUT. Such an adaptive means of compression parameter determination, incorporating analysis of the main and side image content to assess their degree of correlation, is described in co-pending GB patent application no. 0916247.0.

As a compromise between the method of the preferred embodiment and the alternative shown in FIG. 15, rather than ensuring the average off-axis luminance of groups of pixels after modification according to the above process is independent of the input main image data values, or at least has its dependence on the main image data values minimised, the resulting average off-axis luminance can be selected to have some main image value dependence. This can be done in a manner that takes into account the shape of the available off-axis to on-axis luminance space, while keeping the off-axis luminance of key main image values as close as possible, to improve the off-axis luminance contrast between different side image levels.

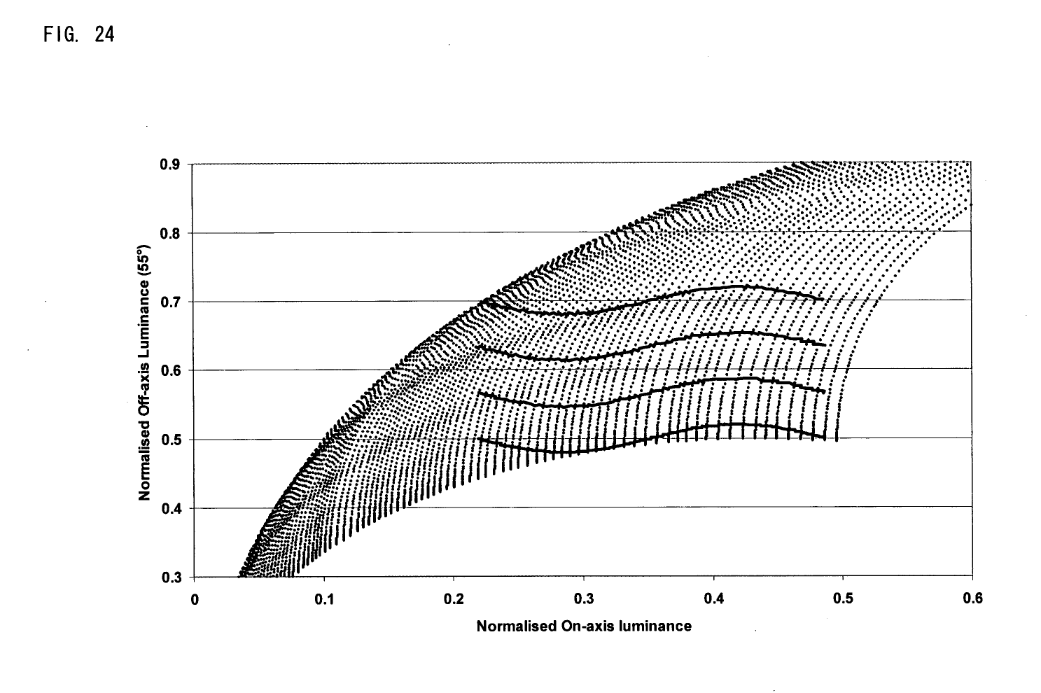

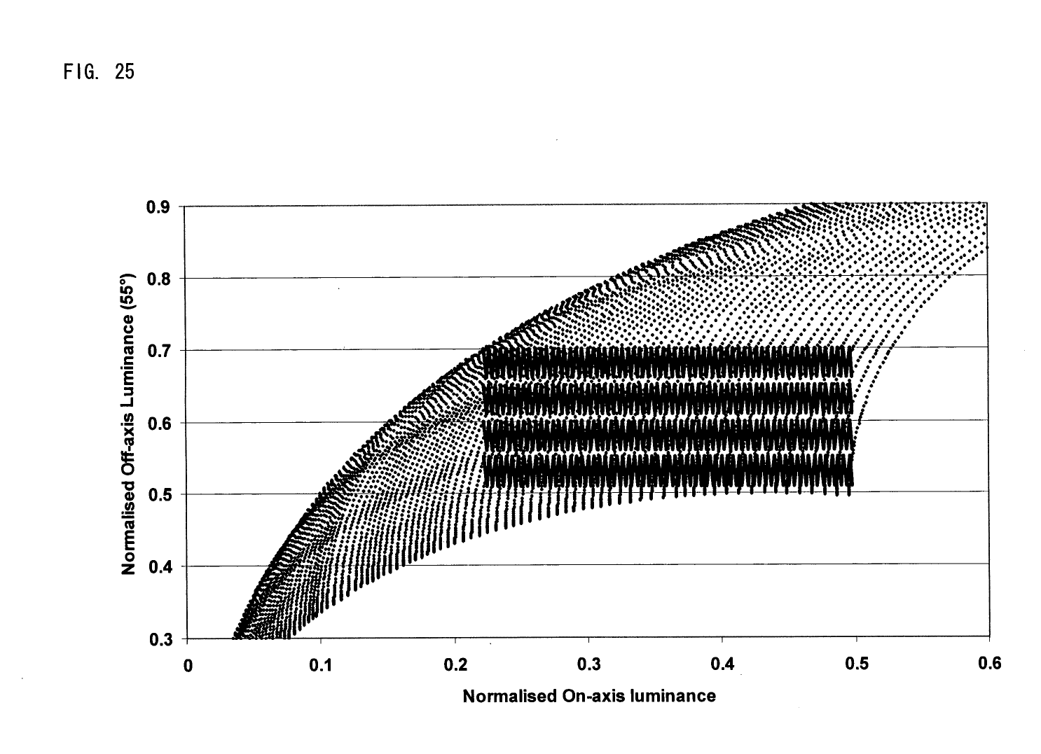

This approach is illustrated in FIG. 24, which shows the average off-axis to on-axis luminance points for groups of pixels modified to cause the off-axis luminance to follow the shape of the available set of points to some degree, increasing the difference in off-axis luminance that can be produced for regions with the same input main image value, but different side image values. It can be seen from this plot that, although the average off-axis luminance for the four side image levels shown is no longer independent of main image value, the off-axis luminance for main image inputs with maximum, minimum and one mid-level value are all equal. This ensures that the privacy effect is still maximised for main image content such as black and white text and images, for which the privacy function may be most important, while still allowing some increase in side-image contrast, at the expense of absolute privacy strength for other main image content.

In a further embodiment, in order to reduce the memory requirement for the LUT used in the mapping process, the fact that the number of sufficiently different on-axis luminance points with the zero-crosstalk region is limited can be used to reduce redundancy in the stored LUT values. As described previously, in order to produce output data pairs for 256 main image values, 4 side image values, and two spatial parameter values, the LUT has 256×4×2 entries, and the compression of the main image may be effectively incorporated in to the LUT. As this built-in compression results in output values for neighbouring main image input values which produce effectively the same on-axis luminance, these redundant entries could be made to produce different off-axis luminance levels, effectively expanding the side-image bit depth at no extra memory requirement.

This method is illustrated in FIG. 25, which shows the average off-axis to on-axis luminance points for groups of pixels modified according to this method. It can be seen that the resulting average off-axis luminance for each of the four side image levels alternates between two set values with alternate main image input values. In this way, the resulting image off-axis luminance is again no longer independent of the input main image data, but has one value for odd main image data values, and a second value for even main image data values. With no expansion of the LUT requirement, the number of available side image levels is effectively doubled, at the expense of halving the number of unique main image values. As discussed, this may not alter the visible appearance of the main image, due to the already existing compression requirement.

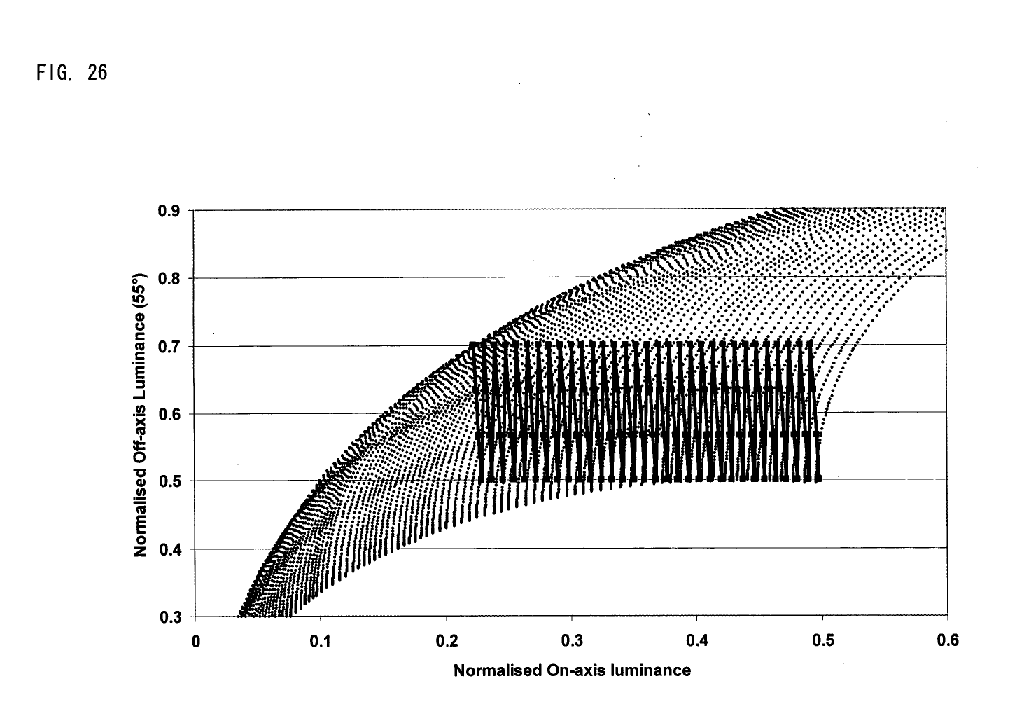

The resulting off-axis to on-axis luminance of a further simplified version of this approach is shown in FIG. 26. In this method, only one 128×2 byte LUT is used, and the main image and side image are previously combined before input to the LUT by replacing the least significant three bits of the 8 bit main image data with the two bits of the side image data. As can be seen from the figure, the resulting 7 bit inputs to the LUT have average output luminances in which the main and side image luminances are no longer independent of each other, the output values have approximately equal off axis-luminance for every fourth input value. This method allows compression of the main image data, and combination with the side image data in a very computationally straightforward manner, and minimises redundancy in the stored LUT values. The method could also be applied for different main and side image bit depths than those illustrated here (e.g. 6 bit main image and 2 bit side image to result in standard 8 bit input values).

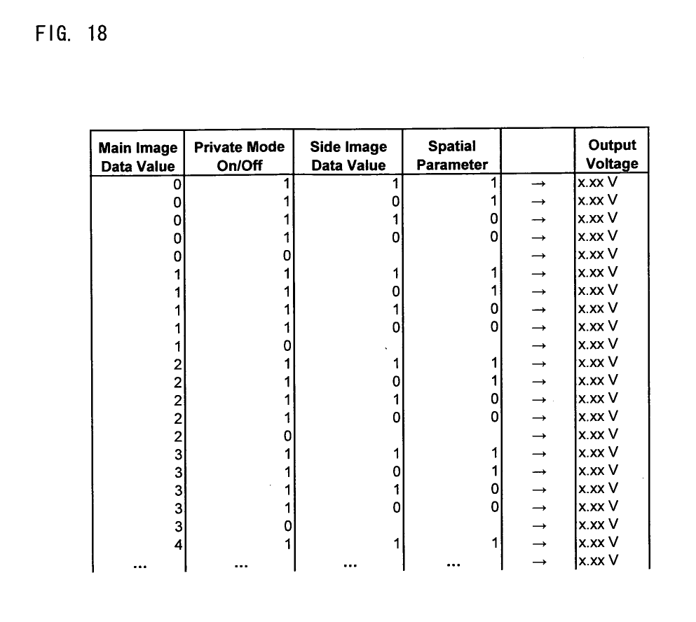

It will be appreciated that the on-axis and off-axis luminance values of more than two individual pixels can be used to provide the overall on-axis and off-axis average luminance points. This allows the area of the envelope of available points to be expanded, as shown in FIG. 17 for the case of groups of four pixels being used to provide an overall average luminance. In the case of an increased number of pixels being used to provide the overall average on-axis and off-axis luminance, the mapping could still have as inputs the main and side image data values for the pixel or group of pixels being modified, as well as the spatial “flag” parameter, which could now have as many values as there are pixels in the group over which averaging takes place. The number of output data values or signal voltage for each combination of main and side image data value may also be correspondingly increased. Each pixel in the group over which averaging occurs could then be assigned a different value for the spatial flag parameter, depending on its position in the display, so that as with previous embodiments, assuming the main and side image data values are constant over the area of the group, within each group all four output values are produced and the desired average on-axis and off-axis luminance results.

It can be seen that unless the display has sufficiently high native resolution that the eye cannot easily resolve individual pixels, or sub-groups of pixels, within such an extended group, and typical image content does not vary significantly over the area of the extended group, ensuring reliable averaging could become problematic. This effect could be mitigated by selection of the pattern of spatial parameter values within the group to minimise visibility of individual pixels or sub-groups of pixels in the same manner that the pattern of spatial parameter values is chosen to be a chequerboard in the embodiments described previously. It could also be mitigated by the application of a main image pre-filtering step, as described in GB0819179.3, or the use of a method which processed the whole group of pixels together as suggested previously.

The effective resolution loss effect could also be mitigated by alternating the value of the spatial “flag” parameter in alternate frames. In this way, the average luminance produced by the two output values in the process LUT may be realised within a single pixel, over two frame periods, rather than over two neighbouring pixels over a single frame period. If they display may be driven sufficiently fast, and has a sufficiently fast response time to react to the data changing in alternate frames, then the observers eye will perceive the average luminance produced by each pixel over two frames, and no apparent resolution loss or display flicker will occur.

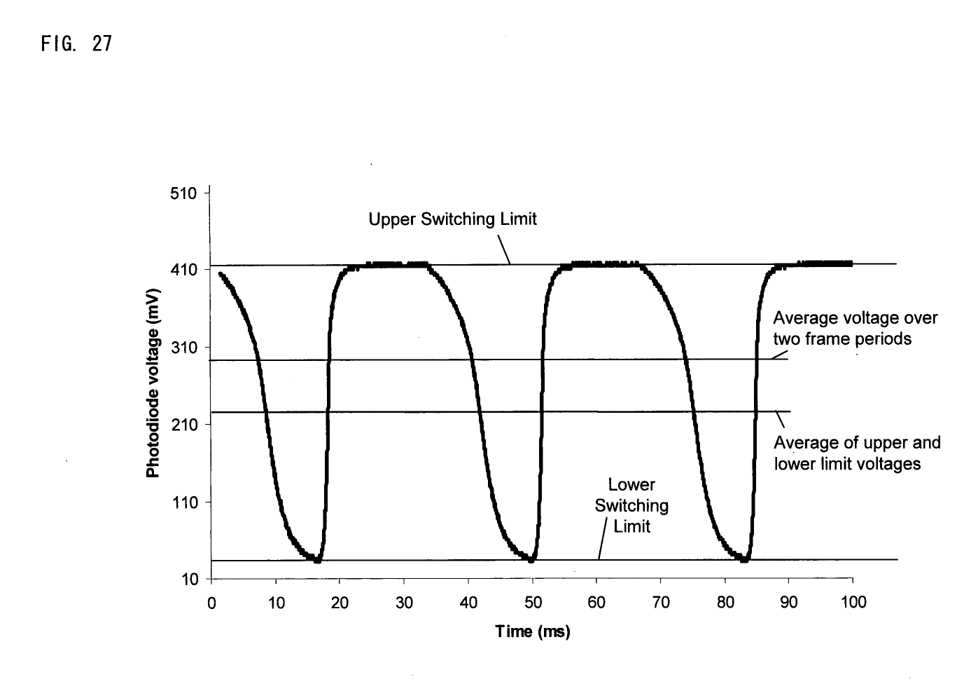

One complication of the above method is that the average luminance produced by a single pixel driven by different data values in alternate frames may well be different to the average luminance produced by the same two data values driven in a static manner. This problem is illustrated in FIG. 27, which shows that if the optical response speed of the display to the data changing from A to B is different to the response of the reverse change, than the average over the two frames will be skewed. In order to pre-calculate an LUT which accounts for this possible discrepancy, a series of measurements of the average on-axis and off-axis luminances of all possible switching combinations may be carried out, or a subset of all these combinations for subsequent 2D interpolation, and the output data values for each input data combination selected from the resulting available set of points in the manner described above. This method of LUT calculation accounting to differing display response time is described, for application in improved wide-viewing displays, in co-pending WO2010071221A1 (published on 24 Jun. 2010), but would also be applicable in this case.

It will be appreciated that, although it is normal to provide a display device which is capable of operating in both public and private modes and switchable between the two modes, the present invention is applicable to display devices capable of operating only in the private mode.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

Some embodiments of the present invention disclose methods in which the pixel group may comprise a single main image pixel and a single spatially corresponding side image pixel, and wherein the output pixel data held by the mapping comprise a pair of output pixel data values, one of the pair being selected as the output pixel data used in the signals determining step.

Some embodiments of the present invention disclose methods in which the mapping may receive as input a spatial parameter which is arranged to control the selection based on the spatial position of the main image pixel of the group within the main image and/or the spatial position of the side image pixel of the group within the side image.

Some embodiments of the present invention disclose methods in which the output pixel data may directly represent the signals used to drive the display panel.

Some embodiments of the present invention disclose methods in which the display device may comprise a mapping portion arranged to map the main image pixel data to display panel drive signals when the claimed method is not operating, and the method may comprise, when the method is operating, sending the output pixel data used in the signals determining step to the mapping portion for mapping to the signals to be applied to the display panel.

Some embodiments of the present invention disclose methods in which the mapping may be arranged to hold output pixel data for the input pixel data which is known to produce an average off-axis luminance with substantially no dependence on the main image pixel data of the group within a predetermined on-axis luminance range.

Some embodiments of the present invention disclose methods in which the predetermined on-axis luminance range may be substantially the same for each possible side image data value, or for each possible combination of side image values where there is more than one side image pixel in the group.

Some embodiments of the present invention disclose methods in which the predetermined on-axis luminance range may extend substantially to the fullest extent possible within an envelope of possible pairs of on-axis and off-axis values for at least one possible side image data value on at least one side of the range, or for at least one possible combination of side image values where there is more than one side image pixel in the group.

Some embodiments of the present invention disclose methods in which the predetermined on-axis luminance range may extend substantially to the fullest extent possible within the envelope, on both sides of the range, for a plurality of possible side image data values, or for a plurality of possible combinations of side image values where there is more than one side image pixel in the group.

Some embodiments of the present invention disclose methods in which each pixel may be a composite pixel comprising a plurality of colour component sub pixels, and the method may be applied in turn to each of the colour component sub pixels.

Some embodiments of the present invention disclose methods in which the predetermined mapping may be performed using a lookup table which is pre-populated with data.

Some embodiments of the present invention disclose methods in which may comprise determining a set of available on-axis/off-axis luminance points for the display device, considering a plurality of lines having different respective constant off-axis luminances, and selecting a plurality of the available luminance points along each of the lines, the selection being made to reduce an error function which depends at least in part on a distance between the point and the line concerned, and populating the lookup table based on the pixel data required to produce the selected luminance points.

Some embodiments of the present invention disclose a program that may be carried on a carrier medium. The carrier medium may be a storage medium. The carrier medium may be a transmission medium.

Some embodiments of the present invention disclose an apparatus or device programmed by a program for controlling an apparatus to perform a method of the present invention or which, when loaded into an apparatus, causes the apparatus to become an apparatus or device of the present invention.

Some embodiments of the present invention disclose a storage medium containing a program for controlling an apparatus to perform a method of the present invention or which, when loaded into an apparatus, causes the apparatus to become an apparatus or device of the present invention.

It will also be appreciated by the person of skill in the art that various modifications may be made to the above-described embodiments without departing from the scope of the present invention as defined by the appended claims.

1. A method of operating a display device comprising a display panel, the method comprising receiving main image pixel data representing a main image, and side image pixel data representing a side image, and for each of a plurality of pixel groups, where each pixel group comprises at least one pixel of the main image pixel data and at least one spatially corresponding pixel of the side image pixel data: performing a predetermined mapping using the pixel data of the pixel group as input, wherein the mapping is arranged to hold output pixel data for the input pixel data which is known to produce an average on-axis luminance which is dependent on the main image pixel data of the group with substantially no dependence on the side image pixel data of the group and an average off-axis luminance which is dependent on the side pixel data of the group with substantially no dependence on the main image pixel data of the group; and determining from the output pixel data the signals used to drive the display panel.

2. A method as claimed in claim 1, wherein the pixel group comprises a single main image pixel and a single spatially corresponding side image pixel, and wherein the output pixel data held by the mapping comprise a pair of output pixel data values, one of the pair being selected as the output pixel data used in the signals determining step.

3. A method as claimed in claim 2, wherein the mapping receives as input a spatial parameter which is arranged to control the selection based on the spatial position of the main image pixel of the group within the main image and/or the spatial position of the side image pixel of the group within the side image.

4. A method as claimed in claim 1, wherein the output pixel data directly represent signals used to drive the display panel.

5. A method as claimed in claim 1, wherein the display device comprises a mapping portion arranged to map the main image pixel data to display panel drive signals when the claimed method is not operating, and comprising, when the method is operating, sending the output pixel data used in the signals determining step to the mapping portion for mapping to the signals used to drive the display panel.

6. A method as claimed in claim 1, wherein the mapping is arranged to hold output pixel data for the input pixel data which is known to produce an average off-axis luminance with substantially no dependence on the main image pixel data of the group within a predetermined on-axis luminance range.

7. A method as claimed in claim 6, wherein the predetermined on-axis luminance range is substantially the same for each possible side image data value, or for each possible combination of side image values where there is more than one side image pixel in the group.

8. A method as claimed in claim 6, wherein the predetermined on-axis luminance range extends substantially to the fullest extent possible within an envelope of possible pairs of on-axis and off-axis values for at least one possible side image data value on at least one side of the range, or for at least one possible combination of side image values where there is more than one side image pixel in the group.

9. A method as claimed in claim 8, wherein the predetermined on-axis luminance range extends substantially to the fullest extent possible within the envelope, on both sides of the range, for a plurality of possible side image data values, or for a plurality of possible combinations of side image values where there is more than one side image pixel in the group.

10. A method as claimed in claim 1, wherein each pixel is a composite pixel comprising a plurality of colour component sub pixels, the method being applied in turn to each of the colour component sub pixels.

11. A method as claimed in claim 1, wherein the predetermined mapping is performed using a lookup table which is pre-populated with data.

12. An apparatus arranged to perform a method as claimed in claim 1.

13. A display device comprising an apparatus as claimed in claim 12.

14. A method of creating a lookup table for use in the method of claim 11, comprising populating the lookup table with output pixel data for each of a plurality of groups of input pixel data, each group of input pixel data comprising pixel data for at least one main image pixel and pixel data for at least one spatially corresponding side image pixel, the output pixel data being known to produce an average on-axis luminance for the display device which is dependent on the main image pixel data of the group with substantially no dependence on the side image pixel data of the group and an average off-axis luminance for the display device which is dependent on the side pixel data of the group with substantially no dependence on the main image pixel data of the group.

15. A method as claimed in claim 14, comprising determining a set of available on-axis/off-axis luminance points for the display device, considering a plurality of lines having different respective constant off-axis luminances, and selecting a plurality of the available luminance points along each of the lines, the selection being made to reduce an error function which depends at least in part on a distance between the point and the line concerned, and populating the lookup table based on the pixel data required to produce the selected luminance points.

16. A lookup table created by a method as claimed in claim 14.

17.-21. (canceled)
